(19) United States
(12) Patent Application Publication
(10) Pub. No.: US 2004/0128814 A1
(43) Pub. Date: Jul. 8, 2004

(54) Assembly tool system and fixture

(76) Inventors: Allan B. Esson, Sarnia (CA); Francis J. Csordas, Kitchener (CA)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/700,174

(22) Filed: Nov. 3, 2003

Related U.S. Application Data
(60) Provisional application No. 60/423,499, filed on Nov. 4, 2002.

(51) Int. Cl. B23P 19/04

(52) U.S. Cl. 29/237

(57) ABSTRACT

A handheld assembly tool system is provided for assembling fluid transfer lines that include a fitting and a tube. In an embodiment of the invention, the assembly tool system includes a fitting fixture for holding the fitting. The fitting fixture includes a flange for supporting the fitting and a selectively adjustable retaining block for securing the fitting against the flange. The assembly tool system also includes a tube fixture for holding the tube and a press device selectively operable to engage and move the fitting fixture such that a portion of the end fitting is forced into the tube.

### CROSS-REFERENCE TO RELATED APPLICATIONS

This application claims priority to U.S. provisional application 60/423,499 filed on Nov. 4, 2002, which is incorporated herein by reference in its entirety.

### BACKGROUND OF THE INVENTION

1. Field of the Invention

The present invention relates to an assembly tool to forcibly connect two components and, more particularly, to an assembly tool and fixture for use with such assembly tool to forcibly connect an end fitting to a length of tubing, such as plastic tubing or a flexible conduit.

2. Description of the Related Art

Fluid transfer lines, such as those used in automotive fuel systems, are well known in the art. Fluid transfer lines commonly include a fluid transfer conduit, such as a flexible tube and semi-rigid, and an end fitting connected to the fluid transfer conduit for securing the fluid transfer line to other components within the system. Fluid transfer lines that include a flexible tube and semi-rigid tube typically connect the tube to the end fitting by sliding an end of the tube over a barbed adapter on the end fitting. The barbs on the adapter are configured to allow the tube to slide onto the end fitting, but resist separation of the tube from the end fitting, particularly when the assembled fluid transfer line is under pressure or has a disturbing force applied.

Apparatus for assembling fluid transfer lines, as described above, typically include fixed machines that assemble large volumes of fluid transfer lines and transportable devices for assembling relatively small numbers of fluid transfer lines. Manufacturers of these assembly apparatus continue to improve upon the designs of the transportable devices to facilitate the ease with which these fluid transfer lines are assembled.

### SUMMARY OF THE INVENTION

A handheld assembly tool system is provided for assembling fluid transfer lines that include a fitting and a tube. In an embodiment of the invention, the assembly tool system includes a fitting fixture for holding the fitting. The fitting fixture includes a flange for supporting the fitting and a selectively adjustable retaining member for securing the fitting against the flange. The assembly tool system also includes a tube fixture for holding the tube and a press device selectively operable to engage and move the fitting fixture such that a portion of the fitting is forced into the tube. A fitting fixture for use with the handheld assembly tool system of the present invention is also disclosed.

### BRIEF DESCRIPTION OF THE DRAWINGS

Embodiments of the invention will now be described, by way of example, with reference to the accompanying drawings, wherein:

FIG. 1 is a side elevation view of a press device according to an embodiment of the present invention;

FIG. 2 is a cross-sectional view of the press device of FIG. 1 taken along line 2-2;

FIG. 3 is an assembled perspective view of a fitting fixture according an embodiment of the present invention;

FIG. 4 is an exploded perspective view of the fitting fixture of FIG. 3;

FIG. 5 is a perspective view of the fitting fixture of FIG. 3 showing a straight or 180° style fitting secured thereto;

FIG. 6 is a perspective view of the fitting fixture of FIG. 3 showing a 90° elbow style fitting secured thereto;

FIG. 7 is a side view of the fitting fixture of FIG. 3 showing a 90° elbow style fitting in contact with a ram of the press device;

FIG. 8 is a side elevation view of a tube fixture according to an embodiment of the present invention;

FIG. 9 is a side elevation view of a press device, fitting fixture and tube fixture prior to inserting a fitting into a tube; and

FIG. 10 is a side elevation view of a press device, fitting fixture and tube fixture of FIG. 9, after insertion of the fitting into the tube.

### DETAILED DESCRIPTION

Referring now to the drawings, FIGS. 9 and 10 illustrate an assembly tool system 20 for assembling a fluid transfer line 21 (sometimes referred to as a hose or tube assembly). In an embodiment of the invention, assembly tool system 20 includes a press device 22 for administering a force to assemble the fluid transfer line, a fitting fixture 24 for holding a fitting portion 26 of fluid transfer line 21 and a tube fixture 28 for holding a tube portion 30 of fluid transfer line 21.

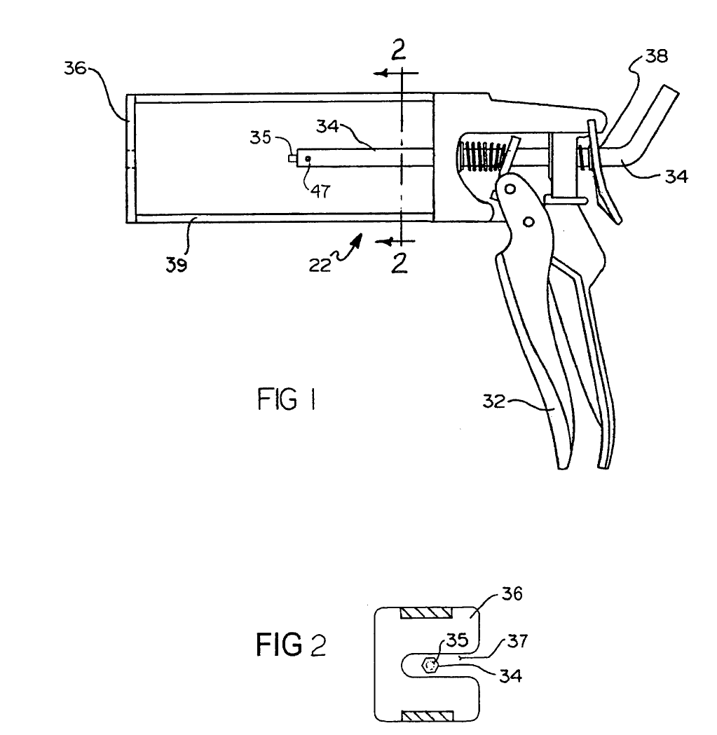

Because the force required to connect tube portion 30 to fitting portion 26 is generally greater than the force available to assemble fluid transfer line 21 by hand, press device 22 is used to provide a mechanical advantage. In the embodiment illustrated in FIGS. 1 and 2, press device 22 functions much like a common caulking gun, for example, wherein a user repeatedly pulls a trigger 32 to move a shaft or ram 34 toward a distal end 36 of press device 22. As shown in FIG. 2, distal end 36 includes a slot 37 sized to allow alignment of tube portion 30 with fitting fixture 24. To release ram 34 for movement in a direction away from distal end 36, a release lever 38 is provided that disengages trigger 32 and/or release lever 38 from ram 34, allowing the user to pull ram 34 away from distal end 36. Press device 22 may also include a support cage 39 to guide movement of fitting fixture 24 and provide support for tube fixture 28.

It will be appreciated that the press device 22 illustrated in FIGS. 1 and 2 is by way of example only and that the press device may incorporate the components and functionality of various caulking gun designs without departing from the scope of the present invention. Furthermore, the overall description of press device 22 set forth above is not intended to be limited to that of a caulking gun, and it is recognized that fitting fixture 24 may be used with other devices capable of producing the force required to connect tube portion 30 to fitting portion 26. For example, press device 22 may incorporate a hydraulically actuated ram or a screw actuated ram driven by an electric motor or by hand (none shown).

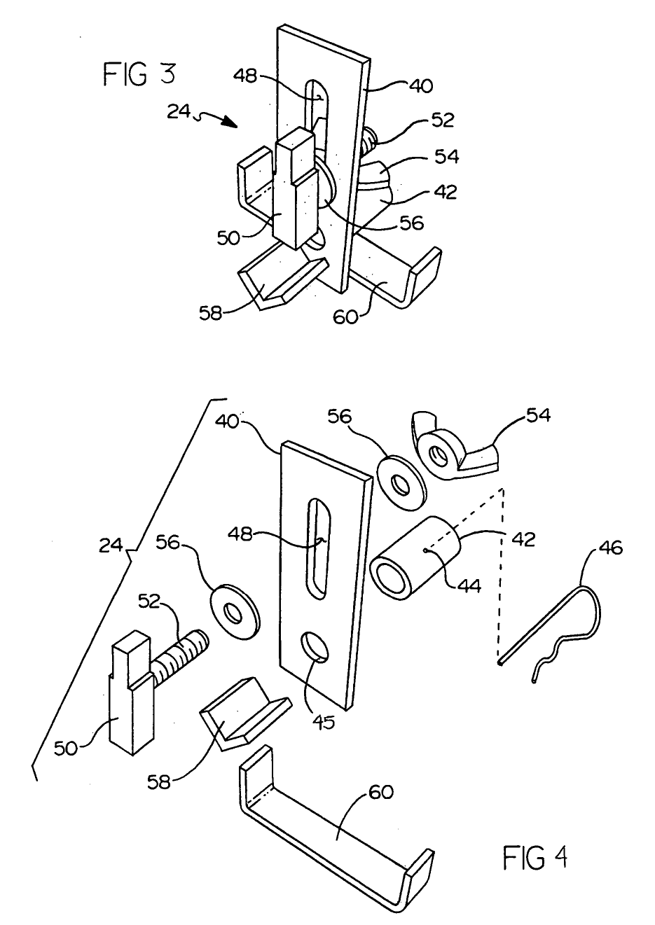

Referring to FIGS. 3 and 4, an embodiment of fitting fixture 24 is shown. In the illustrated embodiment, fitting fixture 24 includes a body 40 having a receptacle 42 that is sized to accept the distal end of ram 34. The walls of receptacle 42 preferably include at least one hole 44 there through, which is sized to receive a retaining member 46, such as a cotter pin and the like. Ram 34 also includes at least one hole 47 therethrough (FIG. 1) that aligns with hole 44 in receptacle 42 to enable the passage of retaining member 46 for connecting fitting fixture 24 to ram 34.

In the illustrated embodiment, fitting fixture 24 also includes a longitudinally extending slot 48 there though. A retainer block 50, which includes a threaded post 52 projecting there from that is slidably received in slot 48, is moveably attached to body 40 by a threaded fastener 54, such as a wing nut and the like. Fastener 54 may be rotated on post 52 against body 40 to prevent movement of retainer block 50 when securing a fitting, and rotated away from body 40 to allow movement of retainer block 50 relative to body 40 to release a fitting. Optionally, a washer 56 may be provided between retainer block 50, fastener 54 and body 40 to facilitate movement therebetween.

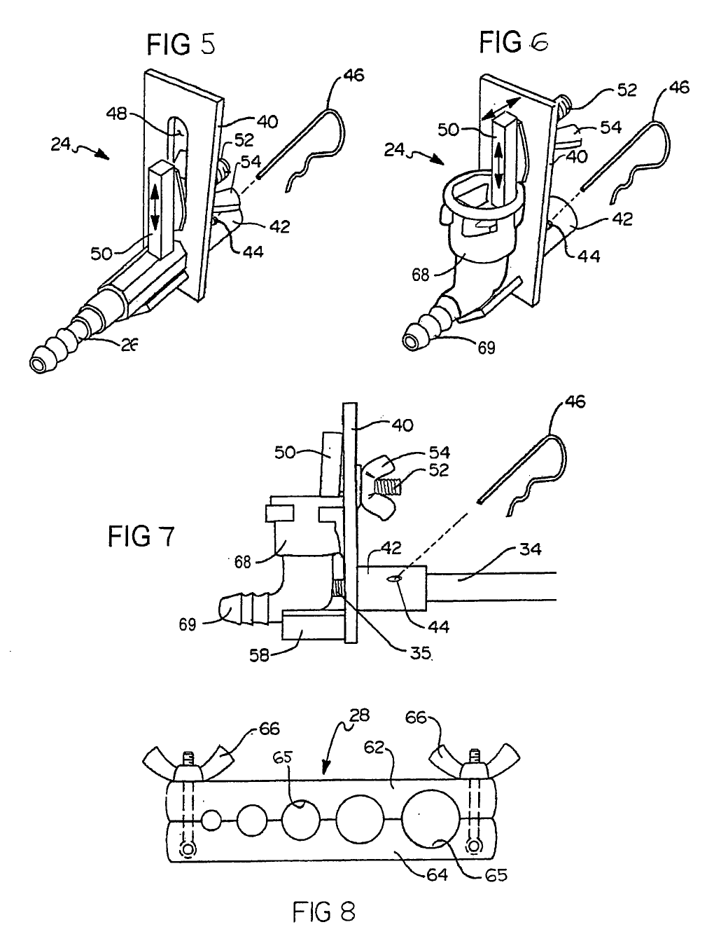

In a particular configuration, fitting fixture 24 also includes a flange 58 that projects outwardly from body 40 below retaining block 50. Flange 58 supports fitting portion 26 during assembly of fluid transfer line 21. Fitting portion 26 is prohibited from moving on flange 58 by retaining block 50, the position of which can be adjusted relative to body 40 to accommodate the various styles and sizes of fittings used. For example, retaining block 50 can be positioned relatively low in slot 48 to accommodate a straight fitting, as shown in FIG. 5, or positioned relatively high in slot 48 to accommodate other fitting configurations, such as a 90° elbow style fitting shown in FIGS. 6 and 7. The cross-sectional profile of flange 58 may be substantially V-shaped, as shown in FIGS. 3 and 4, or may exhibit other geometric shapes, such as a semi-circular shape for example.

In the embodiment illustrated in FIG. 7, a distal end of ram 34 includes a tip 35 that protrudes through a hole 45 in body 40. When a 90° style fitting 68 is secured to fitting fixture 24, tip 35 contacts the 90° elbow fitting 68 to provide a reaction force when pushing the fitting barb 69 into tube 30 and to keep both longitudinal axes of barb 69 and tube 30 substantially parallel.

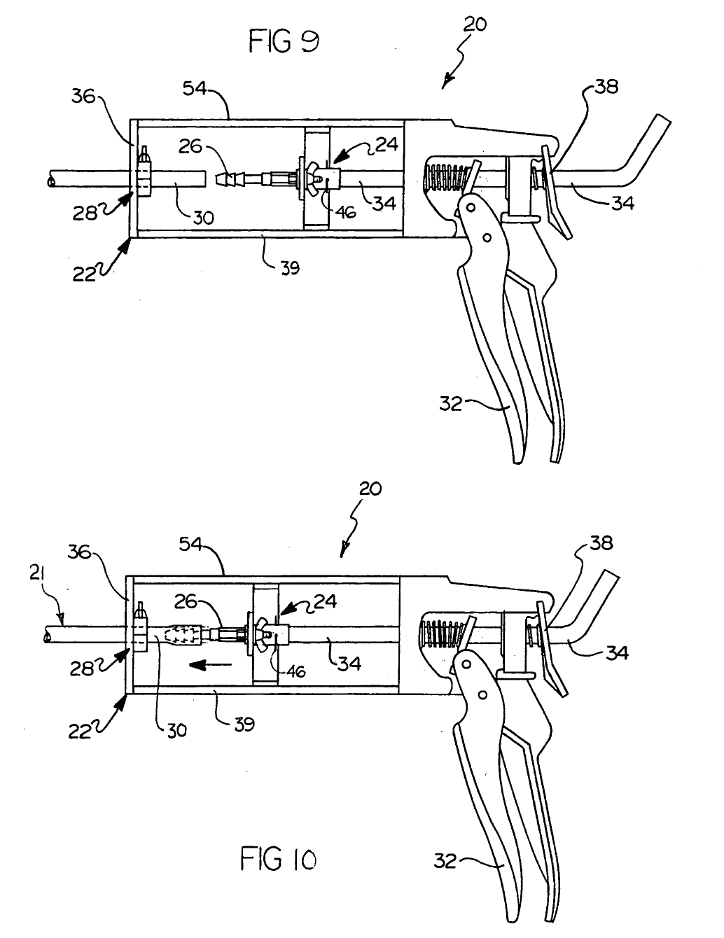

Referring to FIG. 8, an embodiment of tube fixture 28 is shown. In the illustrated embodiment, tube fixture 28 includes a pair of opposing dies 62, 64 that are detachably secured together by a pair of fasteners 66 located at each end of the fixture. Dies 62, 64 include a plurality of half-circle shaped grooves 65 that cooperatively form a number of substantially circular voids for receipt of tube portion 30. The inside diameter of each circular void is slightly smaller than the outside diameter of a corresponding tube portion 30, such that the tube portion 30 is engaged by dies 62, 64 to prevent relative movement there between.

Operation of assembly tool system 20 will now be described with reference to FIGS. 9 and 10. The desired size of fitting portion 26 and tube portion 30 are selected prior to assembly of fluid transfer line 21. Once selected, tube portion 30 is grasped by tube fixture 28, as described above. Tube portion 30 is checked for roundness using a center punch or other suitable gauge and then bent or otherwise worked, if needed, to ensure the end of tube portion 30 protruding from tube fixture 28 is as straight as possible.

Next, fitting portion 26 is positioned on flange 58 of fitting fixture 24 and retainer block 50 is adjusted to engage and secure fitting portion 26 to fitting fixture 24, as described above. Receptacle 42 is then slid over the distal end of ram 34 and secured to ram 34 by inserting fastener 46 through co-aligned holes 44 and 47. Fitting fixture 24 may include an optional guide member 60 that engages either an inner (not shown) or outer surface of support cage 39 to facilitate substantially linear movement of fitting fixture 24 relative to press device 22.

Tube fixture 28 and tube portion 30 are then placed against the inside of support cage 39 near distal end 36 of press device 22 and tube portion 30 is aligned with the barbed end of fitting portion 26 (or barbed end 69 of 90° fitting portion 68). Press device 22 is then operated to advance ram 34 and fitting fixture 24 toward tube portion 30 until the barbed end of fitting portion 26 is pushed into tube portion 30. Retainer block 50 is then disengaged from fitting portion 26, ram 34 and fitting fixture 24 are retracted away from the assembled fluid transfer line 21, and fluid transfer line 21 is removed from tube fixture 28.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A handheld assembly tool system for assembling fluid transfer lines that include a fitting and a tube, comprising:
a fitting fixture for holding the fitting, the fitting fixture including a flange for supporting the fitting and a selectively adjustable retaining member configured to secure the fitting to the fitting fixture;
a tube fixture configured to hold the tube; and
a press device selectively operable to engage and move the fitting fixture such that a portion of the fitting is forced into the tube.

2. The system of claim 1, further including a first fastener for adjusting the position of the retaining member relative to the flange.

3. The system of claim 1, wherein the fitting fixture includes a receptacle for securing the fitting fixture to the press device.

4. The system of claim 3, wherein the receptacle is configured to receive a second fastener to secure the fitting fixture to the press device.

5. The system of claim 1, wherein the press device includes a mechanically actuated ram, the fitting fixture secured to the ram for movement therewith.

6. A fitting fixture for use with a handheld assembly tool to assemble fluid transfer lines that include a fitting and a tube, comprising:
a flange for supporting the fitting;
a selectively adjustable retaining member for securing the fitting against the flange; and
a receptacle for securing the fitting fixture to the assembly tool.

7. The fitting fixture of claim 6, further including a guide member for guiding movement of the fitting fixture relative to the assembly tool.

8. A handheld assembly tool system for assembling fluid transfer lines that include a fitting and a tube, comprising:
a press device including a moveable ram and a support cage;
a fitting fixture for holding the fitting, the fitting fixture including a flange for supporting the fitting, a selectively adjustable retaining block for securing the fitting against the flange and a receptacle for securing the fitting fixture to the movable ram;
a tube fixture configured to hold the fluid conduit; and
whereby the ram selectively operable to move the fitting fixture within the support cage such that a portion of the fitting is forced into the tube.

9. The system of claim 8, further including a first fastener for adjusting the position of the retaining block relative to the flange.

10. The system of claim 8, wherein the receptacle is configured to receive a second fastener to secure the fitting fixture to the press device.

11. The system of claim 8, where the fitting fixture further includes a guide member for guiding movement of the fitting fixture within the support cage.

12. The system of claim 8, wherein the movable ram is positioned to provide a reactive force along substantially parallel longitudinal axes of the fitting and the tube.

13. The system of claim 8, wherein the movable ram is configured to engage the fitting.
